(19) United States
(12) Patent Application Publication
(10) Pub. No.: US 2009/0315408 A1
(43) Pub. Date: Dec. 24, 2009

(54) Energy Efficient power saver

(76) Inventor: Timothy Robert Hall, Greenbrae, CA (US)

Correspondence Address: Timothy Robert Hall, 378 Via La Cumbre, Greenbrae, CA, 94904, US

(21) Appl. No.: 12/117,454

(22) Filed: Jun. 20, 2008

(51) Int. Cl. H01H 35/00

(52) U.S. Cl. 307/126

(57) ABSTRACT

A device that saves electrical energy by turning off power to all computer accessories and/or other devices used at a work station or in the home. When the computer is turn off or goes into sleep mode, away mode or hibernate mode. Also restores power to the accessories when the computer is turned on or awaken from sleep mode, away mode or hibernation mode.

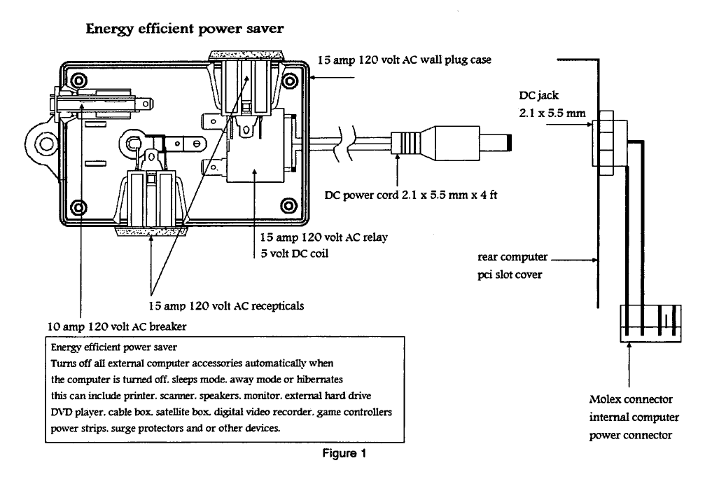

The external case has two electrical recepticals, one for the computer power supply and one for the external accessories. FIG. 1

The external case also has a 10 amp breaker installed to prevent over powering the other parts in the case. FIG. 1

The external case also has a relay to switch the electrical power on and off to the accessories receptical. FIG. 1

The PCI cover for the rear of a computer has a DC power cord that is connected to a internal computer Molex power connector that is used to supply power to internal devices like a hard drive, DVD drive or Floppy disc drive. FIG. 1

The case DC power cord is then pluged into the PCI cover DC connector. FIG. 1

When the computer is turned off, goes into sleep mode, away mode or hibernate mode the power to the internal computer Molex connector is turned off by the computer and that will turn off the relay in the external case and that will turn off the power to the external case accessories receptical to turn off the accessories to save electrical power.

When the computer is turned on, awaken from sleep mode, away mode or hibernation mode. The computer will turn on the power to the internal computer Molex power connector and that will turn on the external case relay that will supply power to the external case accessories receptical to restore electrical power to the external accessories.

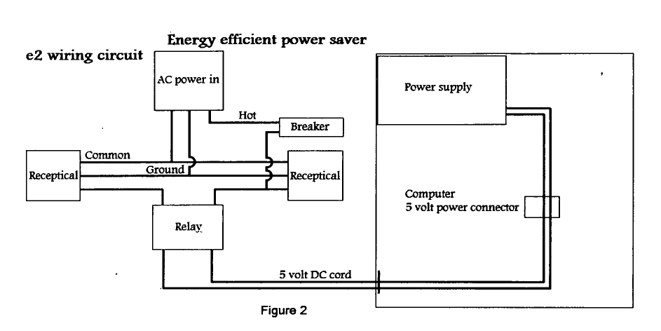

Wiring circuit FIG. 2

I claim:

1. A device for turning off the electrical power to external accessories, when a computer is turned off or goes into sleep mode, away mode or hibernate mode.

2. A device for turning on the electrical power to external accessories, when a computer is turned on or awaken from sleep mode, away mode or hibernation mode
